(19) United States
(12) Patent Application Publication
(10) Pub. No.: US 2008/0032088 A1
(43) Pub. Date: Feb. 7, 2008

(54) Tree trunk wrap for hunters

(76) Inventor: Daniel T. Callan, Addyston, OH (US)

Correspondence Address: JAMES RAY & ASSOCIATES, 2640 PITCAIRN ROAD, MONROEVILLE, PA, 15146, US

(21) Appl. No.: 11/881,025

(22) Filed: Jul. 25, 2007

Related U.S. Application Data
(60) Provisional application No. 60/834,894, filed on Aug. 1, 2006.

(51) Int. Cl. B32B 3/06

(52) U.S. Cl. 428/102

(57) ABSTRACT

A tree trunk wrap manufactured from water-resistant and noise-reducing fabric is disclosed. The tree trunk wrap, designed for use by hunters, comprises a generally rectangular sheet of water-resistant and noise-reducing fabric, adjustable tie straps attached to a first side edge of the generally rectangular sheet, fastening straps attached to a second side edge of the generally rectangular sheet, and fastening means to securely connect each tie strap to a corresponding fastening strap when the invention is wrapped around a tree trunk. The tree trunk wrap of the present invention is useful in a hunter's tree stand, where the noise-reducing fabric muffles sounds resulting from the rustling of clothing articles against the bark of a tree that might otherwise startle a prey animal.

### CROSS REFERENCE TO RELATED APPLICATION

This patent application is related to and claims priority from U.S. Provisional Patent Application Ser. No. 60/834,894, filed Aug. 1, 2006.

### FIELD OF THE INVENTION

The present invention relates, in general, to hunting accessories and, more particularly, this invention relates to a water-resistant and noise-reducing tree trunk wrap for use by a hunter.

### BACKGROUND OF THE INVENTION

Hunters spend extended periods of time in a single position, such as a tree stand, waiting for the appearance of game animals. A hunter often must reach, lean, slide and twist to get into position to take a perfect shot. Such movement, accompanied by the rustling of clothing articles against one another, against the tree stand, or against the bark of a tree, can generate sufficient noise to startle an intended target. There is a need for a simple, economical, water-resistant and noise-reducing covering that can be wrapped around a tree trunk to muffle the noises generated by rustling against the tree. There is an additional need for a lightweight tree trunk wrap that is easy to deploy. The present invention was created in an effort to combine the above features and to improve upon them. Prior to the conception and development of the present invention, as is generally well known in the prior art, a variety of tree trunk protectors utilizing a variety of materials have been disclosed.

U.S. Pat. No. 379,948 to Frantz discloses a tree protector comprising a wire netting trunk wrap with a pad attached on its inner surface. The netting is secured to overlapping longitudinal end rods, and elastic steel bands are secured around the netting and longitudinal end rods. The tree protector disclosed by Frantz is designed to protect the tree from insect infestation and the bark from animals.

U.S. Pat. No. 428,206 to Fouquet discloses a tree protector comprising a fabric or flexible covering, bars longitudinally attached to each end of the covering, said bars including a plurality of apertures, and a series of spring hoops threaded through the apertures, where the spring hoops are employed to tie the bars at each end of the flexible covering together. The tree protector disclosed by Fouquet is designed to protect the trunk of a tree from injury by small animals, and to shield large trees from the action of the sun's heat.

U.S. Pat. No. 5,016,388 to Burress et al. discloses a protective tree guard comprising a finite, flexible net formed of stretch polymeric filaments. The invention of Burress further includes cooperating snap fasteners and drawstrings threaded through sheaths on the upper and lower ends of the net that combine to secure the guard to a tree. The invention disclosed by Burress is intended for protection of a small tree rather than the tree trunk.

The inventions disclosed by Frantz, Fouquet and Burress are directed to protection of a tree or tree trunk from weather, insects or animals, and disclose no application to hunting or reduction of noises caused by rustling of clothing articles against the bark of a tree.

U.S. Pat. No. 5,408,782 to McConnell discloses a tree skirt for use by a hunter to wrap around a tree trunk. The invention of McConnell comprises a reversible sheet of quilted insulating material with camouflage patterns on either exposed side. McConnell further discloses a zipper to bind opposite sides of the sheet together around the tree trunk, and VELCRO™-type fasteners to cinch any excess tree skirt material into a pleated fold. McConnell also discloses a detachable bib flap, attached to a lower portion of the tree skirt to provide a seat barrier or cushion.

The present invention differs from the tree skirt disclosed by McConnell in several aspects. The present invention consists of only a single layer of water-resistant and noise-reducing fabric, resulting in a more lightweight and inexpensive product. The preferred embodiment of present invention is designed such that the tree trunk wrap does not completely circle most tree trunks of the size generally employed as tree stands. Due to the smaller scale of the present invention, a zipper enclosure and cinching means as disclosed and claimed by McConnell are unnecessary. In addition, McConnell does not specifically disclose or claim the adjustable tie straps of the present invention.

### SUMMARY OF THE INVENTION

The present invention provides a tree trunk wrap designed for use by a hunter in a tree stand or similar hunting situations. The tree trunk wrap comprises a single generally rectangular sheet of water-resistant and noise-reducing fabric including a top edge, a first side edge, a second side edge and a bottom edge. The rectangular sheet of fabric includes an exterior surface directed away from the tree trunk, and an interior surface that contacts the trunk. In one embodiment, a hem of fabric is folded toward the interior fabric surface and is sewn around the four edges of the rectangular sheet to reinforce the edges of the wrap and reduce fraying. The fabric is chosen from a group of water-resistant and noise-reducing fabrics known in the art, said fabrics to be discussed in detail in the Brief Description section.

The tree trunk wrap further includes a plurality of relatively longer tie straps sewn to the first side edge of the rectangular sheet, and a plurality of relatively shorter fastening straps sewn to the second side edge of the rectangular sheet. In a preferred embodiment, one tie strap is attached to the first side edge of the rectangular sheet at the corner where the first side edge meets the top edge; likewise, one tie strap is attached to the first side edge of the rectangular sheet at the corner where the first side edge meets the bottom edge. On the opposite edge of the wrap, one fastening strap is attached to the second side edge of the rectangular sheet at the corner where the second side edge meets the top edge; likewise, one fastening strap is attached to the second side edge of the rectangular sheet at the corner where the second side edge meets the bottom edge. Each tie strap sewn on the first side edge has a corresponding fastening strap sewn on the second side edge at the same vertical position on the wrap. Each tie strap and its corresponding fastening strap are secured to one another by fastening means when the trunk wrap is positioned on a tree. In a preferred embodiment, three tie straps and three fastening straps are employed, with straps attached at the top, bottom and center of each side edge.

The tie straps are designed to be adjustable in length to securely fit tree trunks of varying size. The tie straps may be made from elastic materials well-known in the art, or may be adjusted in length utilizing a loop and bar slide mechanism. In this embodiment, an end of the tie strap is fitted through a single bar slide device, then threaded through a plastic loop, then doubled back and threaded through the bar slide once more.

The tie straps and fastening straps may be fastened together by various means known in the art, including hooks, clips, snaps and the like. In a preferred embodiment, the tie straps and fastening straps are firmly secured using a hook-and-loop fastener such as those sold under the trademark VELCRO™. In this embodiment, the tie strap includes a hook strip segment which is oriented toward the interior surface of the rectangular sheet (facing the tree trunk), and the fastening strap includes a loop strip segment oriented toward the exterior surface of the rectangular sheet (away from the tree trunk). Parallel and corresponding pairs consisting of one tie strap and one fastening strap are aligned and interlock when the hook and loop segments are mated.

The tree trunk wrap additionally includes features recognized to be of benefit to hunters, including a camouflage pattern imprinted on the exterior surface of the wrap. The camouflage pattern may be selected to mimic the appearance of tree bark. The tree trunk wrap fabric may be treated with a scent-inhibiting compound selected from such compounds known in the art.

### OBJECTS OF THE INVENTION

It is, therefore, one of the primary objects of the present invention to provide a simple, adjustable, lightweight tree trunk wrap for hunters.

Another object of the present invention is to provide a tree trunk wrap designed to muffle noises generated by the rustling of clothes or other items against the bark of a tree trunk that might startle game animals.

Still another object of the present invention is to provide a waterproof tree trunk wrap designed to maximize the comfort of hunters confined in a single position for extended periods of time, in often inclement conditions.

Yet another object of the present invention is to provide an unobtrusive tree trunk wrap that is simple to deploy in the field.

A final object of the present invention is to provide a tree trunk wrap integrating features designed to improve a hunter's probability of success, such as camouflage patterns and scent-inhibiting compounds.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a front view of the tree trunk wrap of the present invention.

FIG. 2 is an expanded view of the adjustable tie strap, illustrating the loop and bar slide adjustment means.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

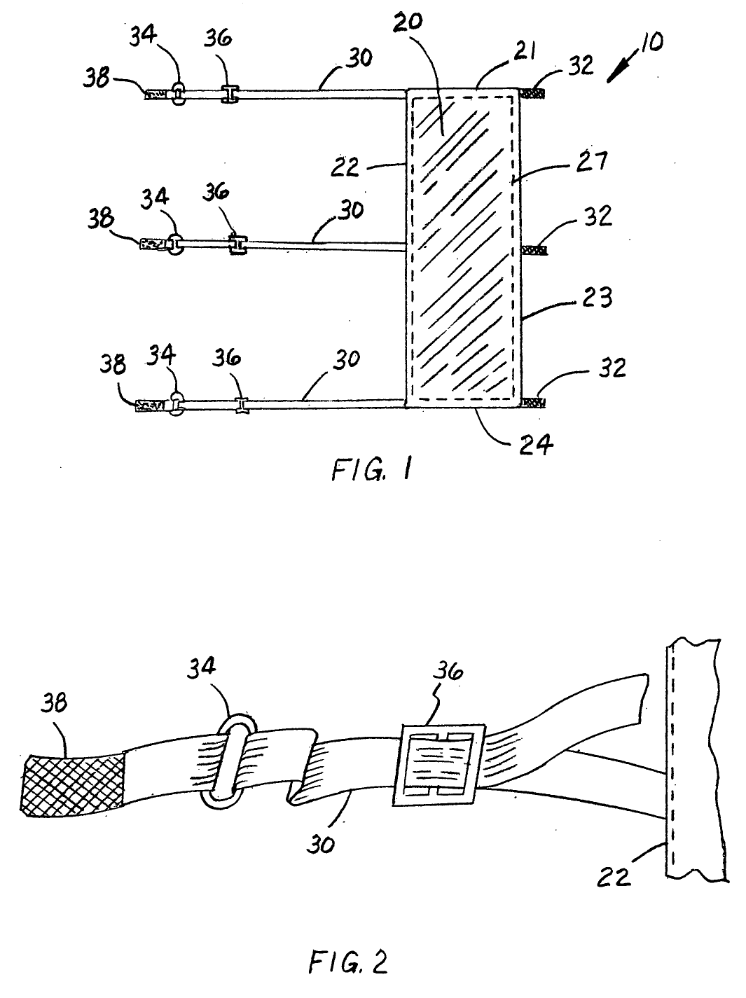

Reference is now made, more particularly, to FIG. 1, which is a front view of the tree trunk wrap of the present invention 10. A rectangular sheet 20 of water-resistant and noise-reducing fabric includes a top edge 21, a first side edge 22, a second side edge 23, and a bottom edge 24. The rectangular sheet includes an exterior surface (shown in FIG. 1) and an interior surface (not visible). A short hem 27 of fabric is folded toward the interior fabric surface, and said hem is sewn around all four edges of the rectangular sheet. The hem reinforces the edges of the wrap and reduces fraying and tattering. The edges of the wrap may alternately be reinforced by flexible inserts, supports, or the like.

Fabric for use in the present invention is selected from the group of water-resistant and noise-reducing fabrics known in the art. U.S. Pat. No. 5,863,633, “Flocked Fabric with Water-Resistant Film” to Squires et al., and U.S. Pat. No. 5,543,195, “Flocked Woven Fabric with Flattened Flock Fibers”, also to Squires et al., hereby incorporated by reference, disclose fabrics suitable for use with the present invention. The fabrics disclosed by Squires et al. prevent prey animals from smelling, hearing or noticing outerwear worn by a hunter in the field, and include a waterproof film laminated onto a woven substrate as well as an applied water repellent. U.S. Pat. No. 5,791,164, “Outdoor Sporting Fabric”, to Carroll et al., hereby incorporated by reference, provides an additional example of a fabric suitable for use in the present invention. Carroll et al. discloses a fabric composed of a polyester yarn base structure with nylon pile yarns knitted to and extending from the base. The fabric disclosed by Carroll et al. exhibits excellent resistance to abrasion, snagging and burr accumulation, while muffling scratching noise emissions in a natural growth environment, such as that of a hunter in the field.

Referring again to FIG. 1, a plurality of tie straps 30 are sewn to the first side edge 22 of the rectangular sheet 20. Likewise, a plurality of fastening straps 32 are sewn to the second side edge 23 of the rectangular sheet 20. As illustrated in FIG. 1, each tie strap attached to the first side edge has a corresponding fastening strap attached to the second side edge in the same vertical position on the rectangular sheet. As additionally illustrated in FIG. 1, each tie strap is considerably longer than its corresponding fastening strap.

In a preferred embodiment, one tie strap 30 is attached to the first side edge 22 of the rectangular sheet 20 at the corner where the first side edge 22 meets the top edge 21; likewise, one tie strap 30 is attached to the first side edge 22 of the rectangular sheet 20 at the corner where the first side edge 22 meets the bottom edge 24. On the opposite edge of the wrap, one fastening strap 32 is attached to the second side edge 23 of the rectangular sheet 20 at the corner where the second side edge 23 meets the top edge 21; likewise, one fastening strap 32 is attached to the second side edge 23 of the rectangular sheet at the corner where the second side edge 23 meets the bottom edge 24. Additional corresponding pairs of tie straps and fastening straps may be distributed along the length of each side edge; in a preferred embodiment, three tie straps and three fastening straps are disposed at the top, bottom and center, respectively, of the appropriate side edge. This preferred embodiment is illustrated in FIG. 1.

The tree trunk wrap of the present invention is secured around the circumference of the tree by extending tie straps 30 and fastening straps 32 into alignment, and joining said straps by fastening means well-known in the art. Suitable fastening means include snaps, hooks, clips and the like. In a preferred embodiment, the tie straps and fastening straps are firmly secured using a hook-and-loop fastener such as VELCRO™. As illustrated in FIG. 1, tie strap 30 includes a short segment of hook-type fastening material 38 at its distal end. Fastening strip 32 is substantially or, in a preferred embodiment, entirely composed of a segment of loop-type fastening material. The hook strip segment 38 at the end of tie strap 30 is oriented toward the interior surface of the rectangular sheet (facing the tree trunk), while the fastening strap loop strip segment is oriented toward the exterior surface of the rectangular sheet (away from the tree trunk). Parallel and corresponding pairs consisting of one tie strap and one fastening strap are aligned and interlock when the hook and loop segments are mated.

The tie straps 30 of the present invention may be adjustable in length, to accommodate tree trunks of various girths. In one embodiment, the tie strap may be manufactured from elastomeric material selected from a large group of such materials known in the art. In a preferred embodiment, the tie strap is adjustable by means of a loop and bar slide mechanism such as that illustrated in FIG. 2.

Referring to FIG. 2, one end of hook-type fastening segment 38 is fitted through an aperture in plastic loop 34, then folded upon itself and sewn so that the hooks face the interior face of the rectangular sheet (toward the tree trunk), as was disclosed above. The free end of tie strap 30 is threaded through a single bar slide member 36, and the bar slide member is slid a short distance down the length of tie strap 30, in the direction of the rectangular sheet. The free end is then fitted through the aperture in plastic loop 34, folded upon itself, and threaded back through the single bar slide member. In this configuration, the length of the tie strap is adjusted by a process of pulling a length of strap from either the free end of the strap or the anchored end, forming a kink of strap material, then pulling the strap taut until a desired length is reached.

The tree trunk wrap of the present invention may further include advantageous features for a user, which are well-known to one skilled in the art of hunting. The exterior surface of the rectangular sheet may be printed with a camouflage pattern to avoid detection by game animals. Many such patterns are known in the art. In one embodiment, a camouflage pattern may mimic the appearance of tree bark. U.S. Pat. No. 4,656,065, “Bark Camouflage Cloth and Outer Garments”, hereby incorporated by reference, discloses a bark camouflage cloth which mimics the colors and textures of tree bark.

In addition to camouflage strategies, hunters often employ scent-inhibiting sprays designed to mask human scents which might alert game animals to the presence of a hunter. Such sprays, including those sold under the trademark ULTRAFRESH™ are well-known in the art and may be selected at the preference of the user. Attractants for deer and other game animals are also well-known in the art and widely marketed. The fabrics utilized in the present invention may be treated with such masking or attracting scents in a strategy designed to make a hunter's tree stand both less conspicuous and more attractive to prey.

The above description of the present invention did not disclose specific sizes or size ranges for the components of the tree trunk wrap. In a preferred embodiment, the tree trunk wrap is as small and lightweight as is possible to still serve its intended purpose. It is not necessary, for instance, for the rectangular fabric sheet to completely encircle a tree trunk by itself; it is sufficient that the fabric sheet in combination with the tie and fastening straps encircle the trunk. In a typical example, said rectangular sheet 20 measures approximately 36-48 inches in height and 18 inches in width. The tie strap 30 is adjustable to approximately 36 inches in length, and the distal segment 38 of the tie strap which includes fastening means extends approximately another 4 inches from plastic loop 34. The fastening strap 32 in this embodiment is approximately 4 inches long, and may be completely composed of loop-type fastener material. The width of the tie and fastening straps must be compatible with the aperture openings of plastic loop 34 and bar slide member 36; in a preferred embodiment, the straps are each approximately 1 inch in width. While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A tree trunk wrap for use by a hunter comprising:
a) a generally rectangular sheet of water-resistant and noise-reducing fabric material, wherein said generally rectangular sheet includes a top edge, a first side edge, a bottom edge, a second side edge, an exterior surface directed away from said tree trunk, and an interior surface contacting said tree trunk;
b) a plurality of tie straps sewn to said first side edge of said rectangular sheet;
c) a plurality of fastening straps sewn to said second side edge of said generally rectangular sheet; and
d) means to fasten at least one tie strap to at least one fastening strap.

2. The tree trunk wrap recited in claim 1, wherein one said tie strap is sewn to said first side edge of said rectangular sheet at said top edge corner, one said tie strap is sewn to said first side edge of said generally rectangular sheet at said bottom edge corner, one said fastening strap is sewn to said second side edge of said generally rectangular sheet at said top edge corner, and one said fastening strap is sewn to said second side edge of said generally rectangular sheet at said bottom edge corner.

3. The tree trunk wrap recited in claim 2, wherein each said tie strap sewn to said first side edge of said generally rectangular sheet is fastened to a corresponding said fastening strap sewn to said second edge of said generally rectangular sheet in the same vertical position.

4. The tree trunk wrap recited in claim 3, wherein said tie straps are adjustable in length.

5. The tree trunk wrap recited in claim 4, wherein said tie straps are adjusted in length by means of a loop and bar slide mechanism.

6. The tree trunk wrap recited in claim 5, wherein said tie straps are made of elastic material.

7. The tree trunk wrap recited in claim 1, wherein said means to fasten said tie strap to said fastening strap includes a hook strip segment on said tie strap and a loop strip segment on said fastening strap.

8. The tree trunk wrap recited in claim 7, wherein said hook strip segment on said tie strap is oriented toward said interior surface of said generally rectangular sheet, and said loop strip segment on said fastening strap is oriented toward said exterior surface of said generally rectangular sheet, such that said loop strip segment and said hook strip segment mate and interlock when aligned.

9. The tree trunk wrap recited in claim 1, wherein said fabric material of said exterior surface further includes a camouflage pattern.

10. The tree trunk wrap recited in claim 9, wherein said camouflage pattern mimics an appearance of tree bark.

11. The tree trunk wrap recited in claim 1, wherein said fabric material is treated with a scent-inhibiting compound.

12. The tree trunk wrap recited in claim 1, wherein a hem of fabric material is folded toward said interior fabric surface and sewn around all four edges of said generally rectangular sheet.
